(19) United States
(12) Patent Application Publication
(10) Pub. No.: US 2008/0179572 A1
(43) Pub. Date: Jul. 31, 2008

(54) Photosensitive Resin Composition for Producing Color Filter and Color Filter for Image Sensor Produced Using the Composition

(75) Inventors: Jae Hyun KIM, Seoul (KR); Kil Sung LEE, Gwacheon-si (KR); Eui June JEONG, Seoul (KR); Chang Min LEE, Goyang-si (KR); Sung Hyok KIM, Hwaseong-si (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 11/965,353

(22) Filed: Dec. 27, 2007

(30) Foreign Application Priority Data
Jan. 5, 2007 (KR) 10-2007-0001200

(51) Int. Cl. G02B 5/20

(52) U.S. Cl. 252/586

(57) ABSTRACT

A photosensitive resin composition for producing a color filter is provided. The composition comprises an alkali-soluble resin, a photopolymerizable monomer, a photopolymerization initiator, a pigment, a dispersant and a solvent. As the dispersant, an amino group-containing maleic acid copolymer resin having long side chains is used. The composition can be used to form a pattern of ultra-fine pixels having a size of up to about 1.0 μm×about 1.0 μm without leaving any residue. Further provided is a high-resolution color filter for an image sensor produced using the composition.

### CROSS-REFERENCE TO RELATED APPLICATION

This non-provisional application claims priority under 35 USC Section 119 from Korean Patent Application No. 10-2007-0001200, filed on Jan. 5, 2007, which is hereby incorporated by reference in its entirety.

### FIELD OF THE INVENTION

The present invention relates to a photosensitive resin composition for producing a color filter and a color filter for an image sensor produced using the composition.

### BACKGROUND OF THE INVENTION

Image sensors are devices that consist of several million photovoltaic devices.

Image sensors convert light to electrical signals corresponding to the intensity of the light. Such image sensors are used to enable digital input devices to record images prior to digitization into digital images. With recent rapid developments in technologies, there has been an exponentially increased demand for image sensors for use in various security systems and digital cameras.

Image sensors comprise an array of pixels, that is, a plurality of pixels arrayed in a two-dimensional matrix form, each of which includes a photodetector and transmission/signal output devices. Image sensors are broadly classified into two types, i.e. charge coupled device (CCD) image sensors and complementary metal oxide semiconductor (CMOS) image sensors, depending on transmission/signal output devices employed in the image sensors.

The structure of a CMOS image sensor is schematically shown in FIG. 1. A color filter of the image sensor functions to separate incident light into red (R), green (G) and blue (B) light components and transmit the separated components to corresponding photodiodes of each pixel.

Research and development have been focused on photosensitive resin compositions, which are compatible with aqueous alkaline developer, for producing color filters only for liquid crystal displays, not for image sensors.

A recent approach to achieve improved image quality of image processing devices, particularly, digital cameras, is to decrease the length of one side of pixels from 3-5 μm down to 1 μm. These conditions require significantly improved pixel materials.

Among patent publications disclosing compositions for producing color filters for image sensors, Korean Patent Publication No. 2006-0052171 and Japanese Patent Publication No. 2004-341121 are directed to methods for forming a fine pattern of about 2.0 μm×2.0 μm. These methods are characterized by the use of dyes as colorants, instead of pigments, to form high-density pixels. However, the fine pixels formed by the compositions suffer from poor long-term reliability since the dyes are highly susceptible to light and heat. (The data show the reliability for one hour to 20 hours maximum.) Japanese Patent Publication No. Hei 7-172032 is directed to a method for the formation of fine R, G and B pixels using a black matrix to prevent color mixing between the pixels and dislocation of the pixels. However, the process requires an additional step to form the black matrix, and it is substantially impossible to elaborately form the black matrix. Further, the black matrix results in a low opening ratio.

### SUMMARY OF THE INVENTION

The present invention provides a photosensitive resin composition that can be useful for producing a color filter for an image sensor. In accordance with this aspect of the present invention, the photosensitive resin composition for producing a color filter comprises an alkali-soluble resin, a photopolymerizable monomer, a photopolymerization initiator, a pigment, a dispersant and a solvent. The dispersant is an amino group-containing maleic acid copolymer having long side chains, which can facilitate the formation of a pattern of ultra-fine square pixels without leaving any residue on unexposed areas. As an example, the resin composition can form a pattern of fine square pixels of about 1.0 μm², and as another example a pattern of fine pixels of about 1.7 μm². The photosensitive resin composition of the present invention can comprise about 0.5 to about 30% by weight of the alkali-soluble resin, about 0.5 to about 30% by weight of the photopolymerizable monomer, about 0.1 to about 10% by weight of the photopolymerization initiator, about 0.1 to about 40% by weight of the pigment, about 0.1 to about 15% by weight of the dispersant, and the balance solvent.

In accordance with another aspect of the present invention, there is provided a color filter for an image sensor which is produced using the photosensitive resin composition.

### BRIEF DESCRIPTION OF THE DRAWINGS

FIG. 1 is a schematic cross-sectional view of a CMOS image sensor.

FIG. 2 is a photograph of a pixel formed in Example 1.

FIG. 3 is a photograph of a pixel formed in Comparative Example 1.

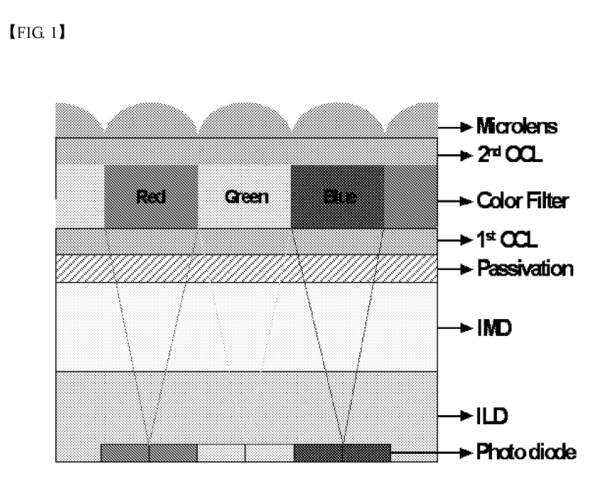

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The alkali-soluble resin used in the present invention is a carboxyl group-containing acrylic binder resin. Specifically, the carboxyl group-containing acrylic binder resin is a copolymer of ethylenically unsaturated monomers having one or more carboxyl groups and other ethylenically unsaturated monomers copolymerizable therewith.

The content of the ethylenically unsaturated monomer having one or more carboxyl groups in the copolymer is in the range of about 10% to about 40% by weight, for example about 20 to about 30% by weight.

The ethylenically unsaturated monomer having one or more carboxyl groups may be acrylic acid, methacrylic acid, maleic acid, itaconic acid, fumaric acid, or a mixture thereof. Examples of ethylenically unsaturated monomers that are copolymerizable with the ethylenically unsaturated monomer having one or more carboxyl groups include without limitation: styrene compounds such as styrene, α-methylstyrene, vinyltoluene and vinylbenzyl methyl ether; unsaturated carboxylic acid esters such as methyl acrylate, methyl methacrylate, ethyl acrylate, ethyl methacrylate, butyl acrylate, butyl methacrylate, 2-hydroxyethyl acrylate, 2-hydroxyethyl methacrylate, 2-hydroxybutyl acrylate, 2-hydroxybutyl methacrylate, benzyl acrylate, benzyl methacrylate, cyclohexyl acrylate, cyclohexyl methacrylate, phenyl acrylate and phenyl methacrylate; unsaturated carboxylic acid aminoalkyl esters such as 2-aminoethyl acrylate, 2-aminoethyl methacrylate, 2-dimethylaminoethyl acrylate and 2-dimethylaminoethyl methacrylate; carboxylic acid vinyl esters such as vinyl acetate and vinyl benzoate; unsaturated carboxylic acid glycidyl esters such as glycidyl acrylate and glycidyl methacrylate; vinyl cyanide compounds such as acrylonitrile and methacrylonitrile; and unsaturated amides such as acrylamide and methacrylamide. One or more monomers selected from the above-mentioned ethylenically unsaturated monomers may be included in the carboxyl group-containing acrylic binder resin.

Examples of carboxyl group-containing acrylic binder resins include without limitation methacrylic acid/methyl methacrylate copolymers, methacrylic acid/benzyl methacrylate copolymers, methacrylic acid/benzyl methacrylate/styrene copolymers, methacrylic acid/benzyl methacrylate/2-hydroxyethyl methacrylate copolymers, and methacrylic acid/benzyl methacrylate/styrene/2-hydroxyethyl methacrylate copolymers.

The composition can include the alkali-soluble resin in an amount between about 0.5% and about 30% by weight, based on the total weight of the composition. When the alkali-soluble resin is present in the composition in an amount of less than about 0.5% by weight, the composition may not be developed with an alkaline developing solution. Meanwhile, when the alkali-soluble resin is present in the composition in an amount exceeding about 30% by weight, the composition is less crosslinked, and the surface turns rough.

The alkali-soluble resin can have a molecular weight (M_{w}) of about 10,000 to about 70,000, for example, about 20,000 to about 50,000.

The alkali-soluble resin is typically the most important factor in determining the resolution of pixels formed using the composition. For example, when a methacrylic acid/benzyl methacrylate copolymer is used as the alkali-soluble resin, the resolution of the pixels formed using the composition is very dependent on the acid value and molecular weight of the copolymer. Experimental results revealed that the best resolution results could be attained when the molar ratio of methacrylic acid to benzyl methacrylate in the copolymer was about 25:75, the acid value of the copolymer was about 80 to about 120 and the molecular weight of the copolymer was about 20,000 to about 40,000.

A conventional photopolymerizable monomer may be used in the present invention. Examples of photopolymerizable monomers suitable for use in the present invention can include without limitation ethylene glycol diacrylate, triethylene glycol diacrylate, 1,4-butanediol diacrylate, 1,6-hexanediol diacrylate, neopentyl glycol diacrylate, pentaerythritol diacrylate, pentaerythritol triacrylate, dipentaerythritol diacrylate, dipentaerythritol triacrylate, dipentaerythritol pentaacrylate, pentaerythritol hexaacrylate, bisphenol A diacrylate, trimethylolpropane triacrylate, novolac epoxy acrylate, ethylene glycol dimethacrylate, diethylene glycol dimethacrylate, triethylene glycol dimethacrylate, propylene glycol dimethacrylate, 1,4-butanediol dimethacrylate, 1,6-hexanediol dimethacrylate, and the like, and mixtures thereof.

The composition can include the photopolymerizable monomer in an amount of about 0.5 to about 30% by weight, based on the total weight of the composition. When the content of the photopolymerizable monomer is less than about 0.5% by weight, edges of pixels formed using the composition may be irregular. When the content of the photopolymerizable monomer is greater than about 30% by weight, the composition may not be developed with an alkaline developing solution.

A conventional photopolymerization initiator may be used in the present invention. Examples of photopolymerization initiators suitable for use in the present invention can include without limitation a triazine compound, an acetophenone compound, a benzophenone compound, a thioxanthone compound, a benzoin compound, and the like, and mixtures thereof.

The composition can include the photopolymerization initiator in an amount of about 0.1% to about 10% by weight, based on the total weight of the composition. The use of the photopolymerization initiator in an amount of less than about 0.1% by weight causes insufficient photopolymerization upon light exposure in a pattern formation process. If, however, the photopolymerization initiator is present in the composition in an amount exceeding about 10% by weight, unreacted initiators may remain in the composition after photopolymerization and deteriorate transmittance.

Examples of triazine compounds suitable for use in the invention a can include without limitation 2,4,6-trichloro-s-triazine, 2-phenyl-4,6-bis(trichloromethyl)-s-triazine, 2-(3′,4′-dimethoxystyryl)-4,6-bis(trichloromethyl)-s-triazine, 2-(4′-methoxynaphthyl)-4,6-bis(trichloromethyl)-s-triazine, 2-(p-methoxyphenyl)-4,6-bis(trichloromethyl)-s-triazine, 2-(p-styryl)-4,6-bis(trichloromethyl)-s-triazine, 2-p-phenyl-4,6-bis(trichloromethyl)-s-triazine, bis(trichloromethyl)-6-styryl-s-triazine, 2-(naphtho-1-yl)-4,6-bis(trichloromethyl)-s-triazine, 2-(4-methoxynaphtho-1-yl)-4,6-bis(trichloromethyl)-s-triazine, 2-4-trichloromethyl(piperonyl)-6-triazine, 2-4-trichloromethyl(4′-methoxystyryl)-6-triazine, and the like, and mixtures thereof.

Examples of acetophenone compounds suitable for use in the invention can include without limitation 2,2′-diethoxyacetophenone, 2,2′-dibutoxyacetophenone, 2-hydroxy-2-methylpropiophenone, p-t-butyltrichloroacetophenone, p-t-butyldichloroacetophenone, benzophenone, 4-chloroacetophenone, 4,4′-dimethylaminobenzophenone, 4,4′-dichlorobenzophenone, 3,3′-dimethyl-2-methoxybenzophenone, 2,2′-dichloro-4-phenoxyacetophenone, 2-methyl-1-(4-(methylthio)phenyl)-2-morpholinopropan-1-one, 2-benzyl-2-dimethylamino-1-(4-morpholinophenyl)-butan-1-one, and the like, and mixtures thereof. Examples of benzophenone compounds suitable for use in the invention can include without limitation benzophenone, benzoylbenzoate, methyl benzoylbenzoate, 4-phenylbenzophenone, hydroxybenzophenone, acrylated benzophenone, 4,4′-bis(dimethylamino)benzophenone, 4,4′-bis(diethylamino)benzophenone, and the like, and mixtures thereof.

Examples of thioxanthone compounds suitable for use in the invention can include without limitation thioxanthone, 2-chlorothioxanthone, 2-methylthioxanthone, isopropylthioxanthone, 2,4-diethylthioxanthone, 2,4-diisopropylthioxanthone, 2-chlorothioxanthone, and the like, and mixtures thereof.

Examples of benzoin compounds suitable for use in the invention can include without limitation benzoin, benzoin methyl ether, benzoin ethyl ether, benzoin isopropyl ether, benzoin isobutyl ether, benzyl dimethyl ketal, and the like, and mixtures thereof.

Other compounds may also be used as a photopolymerization initiator in the present invention, such as but not limited to carbazole compounds, diketone compounds, sulfonium borate compounds, diazo compounds, biimidazole compounds, and the like, as well as mixtures thereof.

Triazine compounds can be particularly useful for the formation of a pattern of ultra-fine square pixels without leaving any residue on unexposed areas. Further, the inventors have found that triazine compounds having maximum absorption in wavelength (λₘₐₓ) of about 340 to about 380 nm most affected the performance of pixel patterns. The present invention has been achieved based on this finding.

Triazine compounds that can be particularly useful in the present invention are represented by Formulae 5, 6, 7 and 8:

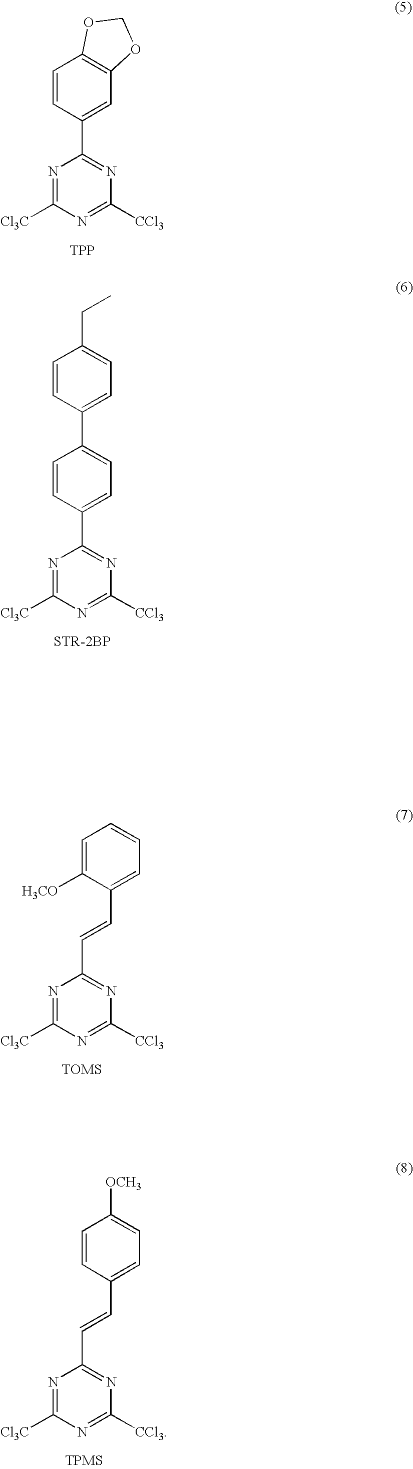

Examples of pigments suitable for use in the present invention include without limitation red, green, blue, yellow and violet pigments. Examples of these pigments include anthraquinone pigments, condensed polycyclic pigments (e.g., perylene pigments), phthalocyanine pigments, and azo pigments, which may be used alone or as a mixture thereof. The use of a mixture of two or more pigments can be useful for adjustment of the maximum absorption wavelength, cross point, cross talk and other conditions.

The pigment used in the present invention can have a primary particle diameter of about 10 to about 70 nm. The use of the pigment having a primary particle diameter smaller than about 10 nm may make a dispersion containing the pigment unstable, while the use of the pigment having a primary particle diameter larger than about 70 nm may unfavorably cause the resolution of pixels formed using the composition to deteriorate. The secondary particle diameter of the pigment is not particularly limited, and can be, for example, smaller than about 200 nm in view of the resolution of pixels formed using the composition.

The composition can include the pigment in an amount of about 0.1 to about 40% by weight, based on the total weight of the composition. When the content of the pigment in the composition is less than about 0.1% by weight, the coloration effects of the pigment are not desirable. When the content of the pigment in the composition exceeds about 40% by weight, the developability of the composition is drastically deteriorated.

The dispersant serves to homogeneously disperse the pigment in the solvent. The dispersant may be any of non-ionic, anionic and cationic dispersants. Examples of such dispersants include without limitation polyalkylene glycols and esters thereof, polyoxyalkylene, polyhydric alcohol esters, alkylene oxide adducts, alcohol alkylene oxide adducts, sulfonic acid esters, sulfonic acid salts, carboxylic acid esters, carboxylic acid salts, alkyl amide alkylene oxide adducts, alkyl amines, and the like. These dispersants may be used alone or in combination of two or more thereof.

Particularly, the photosensitive resin composition of the present invention uses, as the dispersant, an amino group-containing maleic acid copolymer. A representative example of the dispersant is a maleic acid copolymer having structural units of Formulae 1 and 2:

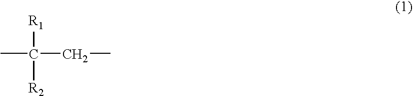

wherein R₁ is a C₁-C₅₀ aliphatic hydrocarbon group or a C₆-C₅₀ aromatic hydrocarbon group, and R₂ is a C₁-C₅ aliphatic hydrocarbon group; and

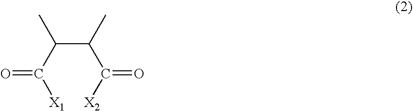

wherein X₁ and X₂ are each independently selected from the following groups 3(A)-3(E):

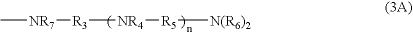

wherein R₃ and R₅ are each independently a C₂-C₆ aliphatic hydrocarbon group or a C₆-C₁₀ aromatic hydrocarbon group, R₄, R₆ and R₇ are each independently a C₁-C₅ aliphatic hydrocarbon group or a hydrogen atom, and n is from 0 to 3;

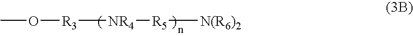

wherein R₃, R₄, R₅, R₆ and n are as defined in 3A;

—NR₈R₉ (3C)

wherein R₈ is a C₁-C₅ aliphatic hydrocarbon group or a hydrogen atom, and R₉ is a C₁₀-C₂₀ aliphatic or aromatic hydrocarbon group, a polyoxyalkylenecarbonyl group having a Mₙ of about 1,000 to about 20,000) or a polyoxyalkylene group having a Mₙ of about 1,000 to about 20,000);

—OR₉ (3D)

wherein R₉ is as defined in 3C; and

—OH (3E), with the proviso that at least one of X₁ and X₂ is 3A, 3B or 3C.

In addition to the structural units of Formulae 1 and 2, the maleic acid copolymer used in the present invention may further include a structural unit of Formula 4:

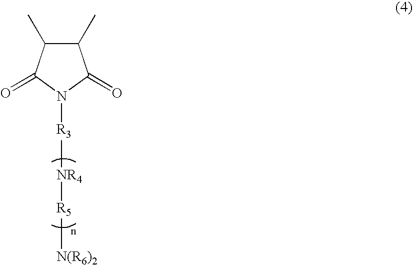

wherein R₃ and R₅ are each independently a C₂-C₆ aliphatic hydrocarbon group or a C₆-C₁₀ aromatic hydrocarbon group, and R₄ and R₆ are each independently a C₁-C₅ aliphatic hydrocarbon group or a hydrogen atom.

Examples of solvents suitable for use in the present invention include without limitation ethylene glycol acetate, ethyl cellosolve, propylene glycol methyl ether acetate, ethyl lactate, polyethylene glycol, cyclohexanone, propylene glycol methyl ether, and the like. These solvents may be used alone or as a mixture of two or more thereof. The composition can include the solvent in an amount of about 20 to about 90% by weight, based on the total weight of the composition, but is not necessarily limited to this range.

If needed, at least one additive selected from malonic acid, 3-amino-1,2-propanediol or fluorinated surfactants may be further added to the composition to prevent the formation of defects and stains in a coating process, to control a leveling process and to obviate residues due to incomplete development of the composition.

The photosensitive resin composition of the present invention is applied to a wafer for a color filter of an image sensor in a thickness of about 0.5 to about 1 μm. The application is performed by any appropriate coating technique, e.g., spin coating or slit coating.

Then, the coated wafer is irradiated with light to form a pattern necessary to produce a color filter for an image sensor. I-line of 356 nm is used as a light source for the irradiation. The coating layer is developed with an alkaline developing solution to dissolve unexposed portions of the coating layer, thus forming a necessary pattern to produce a color filter for an image sensor. This procedure is repeatedly carried out depending on the number of R, G and B colors to produce a color filter having a desired pattern. At this time, the pattern formed after the development may be additionally heated or cured by irradiation with actinic rays to further improve the physical properties such as crack resistance and solvent resistance of the color filter.

Hereinafter, the present invention will be explained in more detail with reference to the following examples. However, these examples are given for the purpose of illustration only and are not to be construed as limiting the scope of the invention.

### EXAMPLES

Example 1
(1) Carboxyl group-containing acrylic resin

| | | |
|---|---|---|
| (A′)/(B′) = 25/75 (w/w), Molecular weight | 5 | g |
| (M_{w}) = 25,000 | | |
| (A′): Methacrylic acid | | |
| (B′): Benzyl methacrylate | | |

(2) Photopolymerizable monomer

| | | |
|---|---|---|
| Dipentaerythritol hexaacrylate (DPHA) | 4.1 | g |

(3) Photopolymerization initiator

| | | |
|---|---|---|
| TPP (Ciba Specialty) | 0.2 | g |
| (4) Pigments | 9 | g |
| Red pigment (BT-CF, Ciba Specialty) | 6.2 | g |
| Yellow pigment (2RP-CF, Ciba Specialty) | 2.8 | g |

(5) Dispersants

| | | |
|---|---|---|
| PB-821 (Ajinomoto) | 2.4 | g |
| Dispersion of carboxyl group-containing | 5.4 | g |
| acrylic binder (the same as (1)) | | |

(6) Solvents

| | | |
|---|---|---|
| Propylene glycol monomethyl ether acetate | 50 | g |
| Ethyl ethoxypropionate | 23.8 | g |

(7) Additive

| | | |
|---|---|---|
| Fluorinated surfactant (F-475) | 0.1 | g |

A photosensitive resin composition is prepared using the above components in accordance with the following procedure:

(1) Dissolve the photopolymerization initiator in the solvents and stir the solution at room temperature for 2 hours;

(2) Add the carboxyl group-containing acrylic binder resin and the photopolymerizable monomer to the solution prepared in (1), followed by stirring at room temperature for 2 hours;

(3) Add the pigments and the dispersants to the mixture obtained in (2), followed by stirring at room temperature for one hour;

(4) Add the surfactant to the mixture obtained in (3), followed by stirring at room temperature for one hour; and

(5) Filter the mixture obtained in (4) three times to remove impurities present therein.

The composition thus prepared is coated on a 6″-wafer as a substrate using a spin coater (1H-DX2, Mikasa) and dried at 100° C. for 180 seconds. The coated wafer is exposed to light using an i-line stepper (NSR i10C, Nikon, Japan) equipped with a reticle, in which patterns having various sizes are provided, for 250 ms, and developed with a 2.38% TMAH solution at room temperature for 120 seconds. The developed structure is cleaned and dried on a plate at a high temperature of 200° C. for 300 seconds to form a pattern. The pattern is observed under a scanning electron microscope (SEM) to determine the resolution of the pattern. A cross section of the pattern is observed by scanning electron microscopy (SEM). The coating thickness is measured using ST4000-DLX (KMAC). The results are summarized in Table 1.

### Examples 2 and 3

The procedure of Example 1 is repeated, except that the kind of the dispersant is varied as shown in Table 1. The results are summarized in Table 1.

### Comparative Examples 1 to 3

The procedure of Example 1 is repeated, except that an acrylic copolymer (Comparative Example 1), a modified polyurethane copolymer (Comparative Example 2) and a polyimine (Comparative Example 3), all of which have a molecular weight, an acid value and an amine value different from those of PB-821 (Ajinomoto) used in the composition of Example 1, are used as dispersants. The results are shown in Table 1.

TABLE 1

| | Dispersant | | Pixel Pattern | |
|---|---|---|---|---|
| | Trade Name (Maker) | Profile | Residue | Resolution (μm)* |
| Example 1 | PB-821 (Ajinomoto) | ◯ | ◯ | 1 × 1 |
| Example 2 | PB-822 (Ajinomoto) | ◯ | ◯ | 1.2 × 1.2 |
| Example 3 | PB-711 (Ajinomoto) | Δ | ◯ | 1.2 × 1.2 |
| Comparative Example 1 | Disperbyk-2000 (BYK Chemie) | X | X | 5 × 5 |
| Comparative Example 2 | Disperbyk-163 (BYK Chemie) | Δ | X | 5 × 5 |
| Comparative Example 3 | 4046 (EFKA) | Δ | X | 3 × 3 |

Note:
*Resolution represents the smallest pixel size discernable

1) Evaluation of Profiles

The cross sections of the pixel patterns (1 μm×1 μm), which are formed using appropriate exposure doses, are observed by scanning electron microscopy (SEM). The pattern profiles are evaluated based on the following criteria:

O—Profile close to a square

Δ—Slightly round profile

X—Substantially circular profile

2) Residue

The cross sections of the pixel patterns (1 μm×1 μm), which are formed using appropriate exposure doses, are observed by SEM. The patterns are evaluated based on the following criteria:

O—No residue is left on unexposed areas

Δ—Residue is slightly left on unexposed areas

X—Residue is obviously observed on unexposed areas

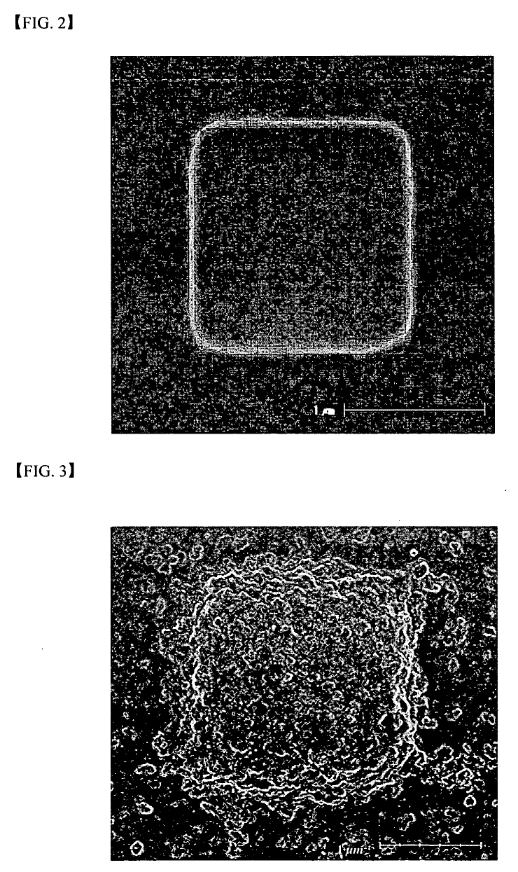

The results of Table 1 demonstrate that the patterns formed in Examples 1 to 3 have a good profile without any residue. In addition, the compositions of Examples 1 to 3 could be used to form high-resolution fine pixels. FIGS. 2 and 3 are photographs of the pixels formed in Example 1 and Comparative Example 1. FIG. 2 shows that no residue is observed in the pixel, whereas FIG. 3 shows that a large amount of residue occurrs in the pixel.

As apparent from the above description, the photosensitive resin composition of the present invention uses a maleic acid copolymer having the structural units of Formulae 1 and 2 as a dispersant. The use of the photosensitive resin composition according to the present invention enables the formation of a pattern of ultra-fine pixels having a square shape without leaving any residue on exposed areas, for example, a pattern of pixel sizes from 1×1 μm to 1.7×1.7 μm. Therefore, the photosensitive resin composition of the present invention can be suitably used to produce a color filter for an image sensor.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A photosensitive resin composition for producing a color filter, the composition comprising an alkali-soluble resin, a photopolymerizable monomer, a photopolymerization initiator, a pigment, a dispersant and a solvent wherein the dispersant is an amino group-containing maleic acid copolymer.

2. The photosensitive resin composition according to claim 1, wherein the maleic acid copolymer comprises structural units of Formulae 1 and 2: 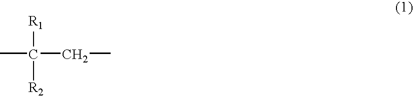
wherein R₁ is a C₁-C₅₀ aliphatic group or a C₆-C₅₀ aromatic hydrocarbon group, and R₂ is a C₁-C₅ aliphatic hydrocarbon group; and 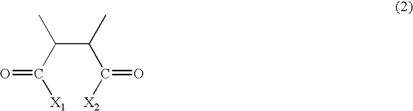
wherein X₁ and X₂ are each independently selected from the following groups 3(A)-3(E): 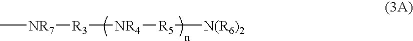
wherein R₃ and R₅ are each independently a C₂-C₆ aliphatic hydrocarbon group or a C₆-C₁₀ aromatic hydrocarbon group, R₄, R₆ and R₇ are each independently a C₁-C₅ aliphatic hydrocarbon group or a hydrogen atom, and n is from 0 to 3; 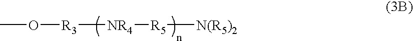
wherein R₃, R₄, R₅, R₆ and n are as defined in 3A;
—NR₈R₉ (3C)
wherein R₈ is a C₁-C₅ aliphatic hydrocarbon group or a hydrogen atom, and R₉ is a C₁₀-C₂₀ aliphatic or aromatic hydrocarbon group, a polyoxyalkylenecarbonyl group having a Mₙ of about 1,000 to about 20,000 or a polyoxyalkylene group having a Mₙ of about 1,000 to about 20,000;
—OR₉ (3D)
wherein R₉ is as defined in 3C; and
—OH (3E), with the proviso that at least one of X₁ and X₂ is 3A, 3B or 3C.

3. The photosensitive resin composition according to claim 2, wherein the maleic acid copolymer further comprises a structural unit of Formula 4: 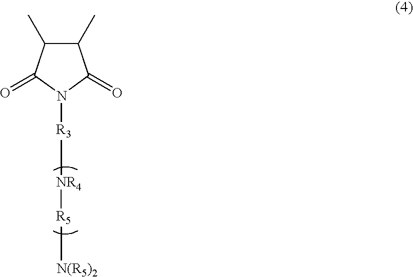
wherein R₃ and R₅ are each independently a C₂-C₆ aliphatic hydrocarbon group or a C₆-C₁₀ aromatic hydrocarbon group, and R₄ and R₆ are each independently a C₁-C₅ aliphatic hydrocarbon group or a hydrogen atom.

4. The photosensitive resin composition according to claim 1, wherein the photosensitive resin composition comprises about 0.5 to about 30% by weight of the alkali-soluble resin, about 0.5 to about 30% by weight of the photopolymerizable monomer, about 0.1 to about 10% by weight of the photopolymerization initiator, about 0.1 to about 40% by weight of the pigment, about 0.1 to about 15% by weight of the dispersant, and the balance solvent.

5. The photosensitive resin composition according to claim 1, wherein the photopolymerization initiator has a maximum absorption in wavelength (λₘₐₓ) of about 340 to about 380 nm and is at least one compound selected from the triazine compounds represented by Formulae 5, 6, 7 and 8:

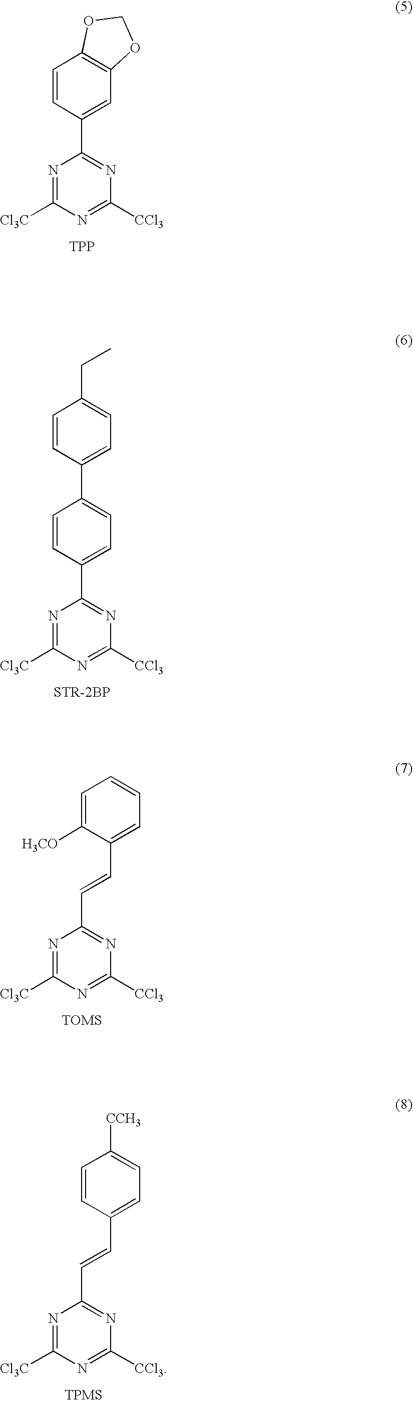

6. The photosensitive resin composition according to claim 1, further comprising about 0.1 to about 0.5% by weight of at least one additive selected from malonic acid, 3-amino-1,2-propanediol or fluorinated surfactants.

7. The photosensitive resin composition according to claim 1, wherein the alkali-soluble resin has a molecular weight (M_{w}) of about 10,000 to about 70,000.

8. The photosensitive resin composition according to claim 1, wherein said carboxyl group containing acrylic resin comprises methacrylic acid/benzyl methacrylate copolymer comprising a molar ratio of methacrylic acid to benzyl methacrylate in the copolymer of about 25:75 and having an acid value of about 80 to about 120 and a molecular weight of about 20,000 to about 40,000.

9. A color filter for an image sensor produced using a photosensitive resin composition comprising an alkali-soluble resin, a photopolymerizable monomer, a photopolymerization initiator, a pigment, a dispersant and a solvent wherein the dispersant is an amino group-containing maleic acid copolymer.

10. A coated substrate useful in a color filter for an image sensor, comprising:
a substrate; and
a pattern of substantially square pixels having a size of about 1×1 to 1.7×1.7 μm comprising a photopolymerized resin comprising pigment and an amino group-containing maleic acid copolymer dispersant on a surface of said substrate.

11. An image sensor comprising a color filter produced using a photosensitive resin composition comprising an alkali-soluble resin, a photopolymerizable monomer, a photopolymerization initiator, a pigment, a dispersant and a solvent wherein the dispersant is an amino group-containing maleic acid copolymer.
